(19) United States
(12) Patent Application Publication
(10) Pub. No.: US 2012/0036697 A1
(43) Pub. Date: Feb. 16, 2012

(54) METHODS FOR INSTALLING DRAINABLE STRUCTURES WITH CONCEALED DRAINS

(76) Inventor: Joseph R. Cook, Parkland, FL (US)

(21) Appl. No.: 12/853,733

(22) Filed: Aug. 10, 2010

(51) Int. Cl. B23P 17/04

(52) U.S. Cl. 29/428

(57) ABSTRACT

The present invention is directed to methods of installation and use of drain and drain concealment structures. The preferred embodiment involves a method of installing and using a drain body and drain cover with a conventional prefabricated waterproof shower or bath pan. The drain body may be connected to the shower pan by any suitable means, such as but not by way of limitation by being integrally molded therewith during manufacture of the pan, by connection post-manufacture or in situ in the field. Other embodiments do not require use of a prefabricated waterproof shower or bath pan. The preferred drain body is comprised of a waterproof structure having a floor section which defines a drain aperture, and a peripheral sidewall section. Structure for releasably attaching a drain cover to the drain body is employed. The cover, which is defined by a peripheral edge, is adapted to lie in registry with, and thereby cover, a portion of the drain body floor so as to conceal the drain aperture and as much of the drain body floor as is practicable. When connected to the drain body, the peripheral edge of the cover is spaced from the drain body sidewall so as to define a gap therebetween through which water may pass while flowing toward the drain aperture. In this way, water is permitted to exit the shower or bath without the drain aperture being visible. The drain apparatus of this invention is preferably utilized as part of a tileable shower or bath arrangement, whereby flooring material such as tile may be placed onto the shower or bath pan up to the peripheral sidewall of the drain body, and additional flooring may be placed upon the drain cover. In this way, the drain is fully operational yet unnoticeable. Interchangeable drain covers may be provided to permit alteration of the decorative appearance of the drain.

### CROSS-REFERENCE TO RELATED APPLICATIONS

The present patent application is related to co-pending and commonly owned U.S. patent application Ser. No. ______, Attorney Docket No. 825343-51, entitled “Cover for Concealed Drain,” U.S. patent application Ser. No. ______, Attorney Docket No. 825343-52, entitled “Improved Tileable Drain and Cover Apparatus,” U.S. patent application Ser. No. ______, Attorney Docket No. 825343-53, entitled “Kits from which may be Manufactured Drainable Structures with Concealed Drains,” and U.S. patent application Ser. No. ______, Attorney Docket No. 825343-55, entitled “Concealed Drainage Apparatus,” filed on even date with the present patent application, the entire teachings of which being hereby incorporated by reference.

### BACKGROUND OF THE INVENTION

1. Field of the Invention

The present invention relates generally to shower pans, drains, and drain tops, grates or covers used in connection with a shower, shower pan, bath, sink, floor, and other surface or fixture, and more particularly to a drain, and to a drain apparatus attached to or used in conjunction with such drain or other drains, which permits a drain top, grate, or cover to be securely attached to and/or over all or a portion of the drain, and such drain top, grate or cover to (i) be tiled; (ii) be removable; (iii) be interchangeable with other drain tops, grates or covers; (iv) allow the drainage of water at or around one or more of the perimeter edges of the drain top, grate or cover; (v) allow the drainage of water in a gap between one or more of the perimeter edges of the tiled or untiled drain top, grate or cover and another grate free tiled or untiled surface, regardless of the orientation of such surface (e.g. vertical, horizontal, etc.) surrounding or adjacent to the drain top, grate or cover; (vi) allow the drainage of water in a gap which is created when the drain top, grate, or cover is placed in registry with the drain body, the peripheral edge of the drain top, grate or cover is spaced from a drain recess peripheral sidewall (defined by the floor off of which liquid is to be drained) so as to define a gap therebetween through which water may pass while flowing toward the drain aperture; (vii) allow such drain and drain tops, grates or covers to be used and to be adapted for use in connection with (A) prefabricated shower pans (such as those described herein), and/or (B) a partially prefabricated shower pan (such as those described herein), and/or (C) a mortar bed or other hand made shower pan floor (such as those described herein), and/or (D) any other tiled or tileable surface or fixture; and (viii) substantially conceal from view the drain aperture.

2. Description of the Prior Art

The inventor is unaware of any shower, bath, shower pan, sink, floor, or drain therefore which employs an attachable, removable, and interchangeable drain top, grate or cover which can be covered with floor or wall coverings such as tile, stone, concrete, stucco, or any other floor or wall coverings, etc, and which permits water to drain (i) at one or more of the grate free perimeter edges of the tiled or tileable drain top, grate, or cover, and/or (ii) in a gap between one or more of the grate free perimeter edges of the tiled or tileable drain top, grate or cover and another grate free surface with tile, stone, and/or other floor or wall coverings, and which makes the drain feature essentially undetectable to ordinary observation. Such an arrangement is highly desirable from an aesthetic perspective. A similar arrangement in which the drain top, grate or cover is not removable would also be desirable.

Therefore, a need exists for, among other things, drains and drain tops, grates and covers (i) which are adapted to be covered with decorative coverings such as floor and wall coverings, (ii) which are attachable to the floor or other surface at or around the drain such as a drain of a shower pan, (iii) which drain tops, grates and covers are optionally removable and interchangeable with other drain tops, grates and covers, (iv) which permit water to drain through a gap between one or more of the perimeter sides of the tiled or tileable drain top, grate or cover and another adjacent or surrounding tiled or tileable surface, (v) which permit water or other liquid to drain in a gap created when the drain cover is placed in registry with the drain body, such that the peripheral edge of the drain cover is spaced from the drain recess peripheral sidewall so as to define a gap therebetween through which water or other liquid may pass while flowing toward the drain aperture, (vi) which permit the drainage of water through a shower, bath, sink, floor or other drain while giving the appearance that there is actually no drain, and (vii) which allow the drains and the drain tops, grates and covers to be used and to be adapted for use in connection with (A) a prefabricated shower pan (such as those defined herein), and/or (B) a prefabricated shower pan (such as those defined herein), and/or (C) a mortar bed or other hand made shower floor (such as those defined herein), and/or (D) tiled or tileable surface or fixture (such as those defined herein).

### SUMMARY OF THE INVENTION

The present invention is directed to shower pans, and drains and drain tops, grates or covers used in connection with a shower, shower pan, bath, sink, floor and other surface or fixture, and which drain tops, grates or covers at least partially cover the drain apparatus, which drain tops, grates or covers are attachable, and optionally removable and/or interchangeable with other drain tops, grates or covers, which drain tops, grates or covers can be covered with tile, stone, or any other floor or wall covering, and which permits water to drain (i) at one or more of the grate free perimeter edges of the tiled or tileable drain top, grate or cover and/or the grate free perimeter edges of the drain apparatus, and/or (ii) through a gap between one or more of the perimeter edges of the tiled or tileable drain top, grate or cover and another adjacent or surrounding horizontal and/or vertical tiled or tileable surface, and/or (iii) which permits water or other liquid to drain in a gap created when the drain cover is placed in registry with the drain body, such that the peripheral edge of the drain cover is spaced from the drain recess peripheral sidewall so as to define a gap therebetween through which water or other liquid may pass while flowing toward the drain aperture, and (iv) which permits ample drainage from the shower, shower pan, bath, sink, floor, fixture or other drain structure while making the drain apparatus essentially undetectable. A drain body defines a drain aperture which is adapted to be placed in registry with a shower, shower pan, bath, sink, floor, fixture or other drain conduit. A drain top, grate, or cover is associated with the drain body in such a way that it covers substantially the entirety of the drain aperture, allows the drainage of water along the perimeter edges or within the body of the drain top, grate or cover, and/or may be manufactured so as to be attachable and removable from the drain body, and/or interchangeable with other drain tops, grates or covers, and permits the water or other liquid to drain in a grate free area at one or more of the perimeter edges of the drain top, grate or cover and or drain apparatus, and/or in a gap between one or more grate free edges of the tiled drain top, grate or cover and another adjacent tiled or tileable surface, including but not limited to an adjacent tiled shower pan surface, shower floor surface, bath, sink, fixture, floor, or other tiled or tileable surface, while essentially making the drain apparatus undetectable from view yet permitting water to flow into and through the drain aperture. The floor or wall covering may be attached to the drain top, grate or cover at any time, including, but not limited to, (i) at or about the time of manufacture of the drain and/or the drain top, grate or cover, (ii) at or about the time of the manufacture of the shower pan, shower, floor, sink, bath, fixture or other tiled or tileable surface or other apparatus into which the drain has been or will be integrated, (iii) at or about the time the drain apparatus, or other article or fixture into which the drain has been or will be integrated, is installed over a drain aperture in the field, and/or (iv) at any time after the drain and/or a the shower pan, floor, sink, bath fixture or other surface into which the drain has been integrated, is installed in the field.

In one embodiment, a drain body is integrally formed with a prefabricated shower pan (as defined herein) at the time of manufacture of the shower pan, such as, but not limited to, the type of prefabricated shower pan disclosed in U.S. Pat. No. 5,913,777 entitled “Pre-Fabricated Shower Module and Method of Shower Construction.” The drain body defines a drain aperture which is adapted to be placed in registry with the floor of the prefabricated shower pan in such a manner that the drain is sufficiently recessed below the shower pan floor to accommodate a tileable drain top, grate, or cover. A drain top, grate or cover, which can be covered with stone, tile, concrete, stucco or other floor or wall covering, is associated with the drain body and the prefabricated shower pan surface in such a way that (i) it covers the drain so that an upper surface of the drain cover is substantially coplanar with an upper surface of the adjacent floor of the prefabricated shower pan surface, (ii) both the prefabricated shower pan and the drain top, grate or cover can be covered with tile, stone, or other floor or wall covering, so that the drain will blend into the flooring material used on the surrounding prefabricated shower pan floor, (iii) the drain top, grate or cover is attachable to the drain, which drain is integrated into the prefabricated shower pan, (iv) the drain top, grate or cover is optionally removable and/or interchangeable with other drain tops, grates and covers, (v) the drain top, grate or cover permits water to drain into the drain apparatus along the outside perimeter of the drain top, grate or cover and/or the drain apparatus, (vi) the drain top, grate or cover also permits water or other liquid to drain in a gap created when the drain cover is placed in registry with the drain body, such that the peripheral edge of the drain cover is spaced from the drain recess peripheral sidewall defined by the shower pan so as to define a gap therebetween through which water or other liquid may pass while flowing toward the drain aperture, and (vii) the drain top, grate or cover permits water to drain into a gap between one or more of the perimeter tiled or tileable edges of the drain top, grate or cover and one or more of the adjacent tiled or tileable perimeter edges of the drain recess in the prefabricated shower pan, (viii) the drain is sufficiently recessed into or below an upper surface of the prefabricated shower pan floor so that an upper surface of the tiled or tileable drain top, grate, or cover when attached in registry with the drain is substantially coplanar with the adjacent upper surface of the tiled or tileable prefabricated shower pan floor, and the lower surface of the attached drain top, grate or cover and the upper surface of the drain body floor are spaced so that a sufficient gap is created so as to allow for water to drain therethrough into the drain aperture, (ix) the drain top, grate or cover substantially covers the entirety of the drain aperture and the drain apparatus from view while permitting water to flow into and through the drain apparatus and aperture, (x) optionally, a removable strainer can be placed between the drain top, grate or cover and the drain aperture. The drain top grate or cover can be made of any appropriate material including but not limited to plastic such as PVC or ABS, polyurethane, polyethylene, metal such as copper, cast iron, aluminum, steel, or building materials such as stone, concrete, marble, cultured marble, mortar, stucco or any other material.

In another embodiment, a drain body is integrally formed with a partially prefabricated shower pan of the type which does not have an integrated drain, such that the drain is attached to the partially prefabricated shower pan sometime after manufacture, and in many cases in the field at or about the time of installation of the partially prefabricated shower pan. The drain body defines a drain aperture which is adapted to be placed in registry with the floor of a partially prefabricated shower pan in such a manner that the drain body is sufficiently recessed into or below the partially prefabricated shower pan floor to accommodate a drain top, grate or cover. A drain top, grate or cover, which can be covered with stone, tile, concrete, stucco or other floor or wall covering, is associated with the drain body in such a way that (i) it covers all or a portion of the drain so that an upper surface of the drain cover is substantially coplanar with an upper surface of the floor of the partially prefabricated shower pan surface, (ii) both the partially prefabricated shower pan and the drain top, grate or cover can be covered with tile, stone, or other floor or wall covering, so that it will blend into the flooring material used on the surrounding partially prefabricated shower pan floor, (iii) the drain top, grate or cover is attachable to the drain or the partially prefabricated shower pan, (iv) the drain top, grate or cover is optionally removable and/or interchangeable with other drain tops, grates and covers, (v) the drain top, grate or cover permits water to drain into the drain apparatus along the outside perimeter of the drain top, grate or cover and/or the drain apparatus, (vi) the drain top, grate or cover also permits water or other liquid to drain in a gap created when the drain cover is placed in registry with the drain body, such that the peripheral edge of the drain cover is spaced from the drain recess peripheral sidewall so as to define a gap therebetween through which water or other liquid may pass while flowing toward the drain aperture, and (vii) the drain top, grate or cover permits water to drain into a gap between one or more of the perimeter tiled or tileable edges of the drain top, grate or cover and one or more of the adjacent tiled or tileable perimeter edges of the drain recess in the partially prefabricated shower pan, (viii) the drain is sufficiently recessed into or below an upper surface of the partially prefabricated shower pan floor so that an upper surface of the tiled or tileable drain top, grate, or cover when attached in substantial registry with the drain is substantially coplanar with the adjacent upper surface of the tiled or tileable partially prefabricated shower pan floor, and the lower surface of the attached drain top, grate or cover and the upper surface of the drain body floor are spaced so that a sufficient gap is created so as to allow for water to drain therethrough into the drain aperture, (ix) the drain top, grate or cover covers substantially the entirety of the drain aperture and the drain apparatus from view while permitting water to flow into and through the drain apparatus and aperture, and (x) optionally, a removable strainer can be placed between the drain top, grate or cover and the drain aperture. The cover can be made of any appropriate material including but not limited to plastic such as PVC or ABS, polyurethane, polyethylene, metal such as copper, cast iron, aluminum, steel, or building materials such as stone, concrete, marble, cultured marble, mortar, stucco or any other material.

In another embodiment, a drain body is integrally formed with a mortar bed or other hand-made shower pan, bath or other floor (as herein defined) which may or may not be constructed in conjunction with a vinyl liner or other water proofing membrane(s). The drain body defines a drain aperture which is adapted to be placed in registry with the floor of a mortar bed or other hand-made shower floor, bath floor, floor, or other surface in such a manner that the drain body is sufficiently recessed in the mortar bed or below the shower, bath, or other floor to accommodate a drain top, grate, or cover. A drain top, grate or cover, which can be covered with stone, tile, concrete, stucco or other floor or wall covering, is associated with the drain body in such a way that (i) it covers the drain so that an upper surface of the drain cover is substantially coplanar with an upper surface of the floor of the mortar bed or other hand-made shower pan floor, (ii) both the mortar bed or other hand-made shower pan floor and the drain top, grate or cover can be covered with tile, stone, or other floor or wall covering, so that the drain top, grate or cover will blend into the flooring material used on the surrounding mortar bed or other hand made shower pan floor, (iii) the drain top, grate or cover is attachable to the drain or the mortar bed or other hand-made shower pan floor, (iv) the drain top, grate or cover is optionally removable and/or interchangeable with other drain tops, grates and covers, (v) the drain top, grate or cover permits water to drain into the drain apparatus along the outside perimeter of the drain top, grate or cover and/or the drain apparatus, (vi) the drain top, grate or cover also permits water or other liquid to drain in a gap created when the drain cover is placed in registry with the drain body, such that the peripheral edge of the drain cover is spaced from the drain recess peripheral sidewall so as to define a gap therebetween through which water or other liquid may pass while flowing toward the drain aperture, and (vii) the drain top, grate or cover also permits water to drain into a gap between one or more of the perimeter tiled or tileable edges of the drain top, grate or cover and one or more of the adjacent tiled or tileable perimeter edges of the drain recess portion of the mortar bed or other hand made shower pan floor, (viii) the drain is sufficiently recessed into or below an upper surface of the mortar bed or other hand made shower pan floor so that an upper surface of the tiled or tileable drain top, grate, or cover when attached in registry with the drain is substantially coplanar with the adjacent upper surface of the tiled or tileable mortar bed or other hand made shower pan, and the lower surface of the attached drain top, grate or cover and the upper surface of the drain body floor are spaced so that a sufficient gap is created so as to allow for water to drain therethrough into the drain aperture, (ix) the drain top, grate or cover substantially covers the entirety of the drain aperture and the all or a portion of the drain apparatus from view while permitting water to flow into and through the drain apparatus and aperture, and (x) optionally, a removable strainer can be placed between the drain top, grate or cover and the drain aperture. The cover can be made of any appropriate material including but not limited to plastic such as PVC or ABS, polyurethane, polyethylene, metal such as copper, cast iron, aluminum, steel, or building materials such as stone, concrete, marble, cultured marble, mortar, stucco or any other material.

In yet another embodiment, a drain body is integrally formed with a tiled or tileable surface or fixture that has a drain, in such a manner that the drain body defines a drain aperture which is adapted to be placed in registry with a tiled or tileable surface or fixture that has a drain in such a manner as to be sufficiently recessed to accommodate a drain top, grate, or cover. A drain top, grate or cover, which can be covered with stone, tile, concrete, stucco or other floor or wall covering, is associated with the drain body in such a way that (i) it covers the drain so that an upper surface of the drain cover is substantially coplanar with an upper surface of the tiled or tileable surface or fixture, (ii) both the tiled or tileable surface or fixture and the drain top, grate or cover can be covered with tile, stone, or other floor or wall covering, so that it will blend into the flooring material used on the surrounding tiled or tileable surface or fixture, (iii) the drain top, grate or cover is attachable to the drain or the tiled or tileable surface or fixture, (iv) the drain top, grate or cover is optionally removable and/or interchangeable with other drain tops, grates and covers, (v) the drain top, grate or cover permits water to drain into the drain apparatus along the outside perimeter of the drain top, grate or cover and/or the drain apparatus, (vi) the drain top, grate or cover also permits water or other liquid to drain in a gap created when the drain cover is placed in registry with the drain body, such that the peripheral edge of the drain cover is spaced from the drain recess peripheral sidewall so as to define a gap therebetween through which water or other liquid may pass while flowing toward the drain aperture, and (vii) the drain top, grate or cover permits water to drain into a gap between one or more of the perimeter tiled or tileable edges of the drain top, grate or cover and one or more of the tiled or tileable perimeter edges of the drain recess portion of the tiled or tileable surface or fixture, (viii) the drain is sufficiently recessed into or below an upper surface of the tiled or tileable surface or fixture so that an upper surface of the tiled or tileable drain top, grate, or cover when attached in substantial registry with the drain is substantially coplanar with the adjacent upper surface of the tiled or tileable surface or fixture, and the lower surface of the attached drain top, grate or cover and the upper surface of the drain body floor are spaced so that a sufficient gap is created so as to allow for water to drain therethrough into the drain aperture, (ix) the drain top, grate or cover covers substantially the entirety of the drain aperture and the drain apparatus from view while permitting water to flow into and through the drain apparatus and aperture, and (x) optionally, a removable strainer can be placed between the drain top, grate or cover and the drain aperture. The cover can be made of any appropriate material including but not limited to plastic such as PVC or ABS, polyurethane, polyethylene, metal such as copper, cast iron, aluminum, steel, or building materials such as stone, concrete, marble, cultured marble, mortar, stucco or any other material.

### BRIEF DESCRIPTION OF THE DRAWINGS

FIG. 1 is a front/top right perspective view of an assembled shower or bath drain apparatus in accordance with an exemplary embodiment of the present invention.

FIG. 2 is a front/top right perspective exploded view of the shower or bath drain apparatus in accordance with an exemplary embodiment of the present invention.

FIG. 3 is a front/top right perspective view of a drain body in accordance with an exemplary embodiment of this invention.

FIG. 4 is a right side elevational view of the drain body in accordance with an exemplary embodiment of this invention.

FIG. 5 is a bottom elevational view of a drain cover in accordance with an exemplary embodiment of this invention.

FIG. 6 is a perspective view of an optional drain insert adaptable for use with this invention.

FIG. 7 is a perspective view of the optional drain insert connected to the drain body.

FIG. 8 is a cross-sectional side elevational view of the assembled shower or bath drain apparatus in accordance with the first embodiment of the present invention taken along line A-A of FIG. 20.

FIG. 9 is a cross-sectional side elevational view of the assembled shower or bath drain apparatus in accordance with a second embodiment of the present invention taken along line A-A of FIG. 20.

FIG. 10 is a perspective exploded view of the shower or bath drain body shown in FIG. 7 with an example of an alternative drain strainer exploded therefrom.

FIG. 11 is a perspective exploded view of the shower or bath drain body shown in FIG. 10 with an example of an alternative drain strainer attached thereto.

FIG. 12 is a cross-sectional side elevational view of the assembled shower or bath drain apparatus shown in FIG. 8 with a modified floor and drain insert assembly taken along line A-A of FIG. 20.

FIG. 13 is a cross-sectional side elevational view of the assembled shower or bath drain apparatus shown in FIG. 9 with a modified floor and drain insert assembly taken along line A-A of FIG. 20.

FIG. 14 is a cross-sectional side elevational view similar to that shown in FIG. 8 but where strainer 40 and strainer cover 42 are replaced by strainer 110.

FIG. 15 is a cross-sectional elevational view similar to that shown in FIG. 8, showing the use of spacers 190 to adjust the level of cover C relative to pan floor surface P.

FIG. 16 is an exploded view of an alternative embodiment of the drain apparatus in this invention.

FIG. 17 is a bottom elevational view of a drain cover in accordance with the embodiment of this invention shown in FIG. 16.

FIG. 18 is a perspective view of a prefabricated shower pan and integrated drain body prior to being covered with flooring material in accordance with this invention.

FIG. 19 is the prefabricated shower pan of FIG. 18 after having been covered with flooring material.

FIG. 20 is a top plan view of the pan and drain arrangement of FIG. 18.

FIG. 21 is a cross-sectional side elevational view of the assembled shower or bath drain apparatus in accordance with a modified embodiment of the present invention taken along line A-A of FIG. 20.

FIG. 22 is an exploded perspective view of the shower or bath drain apparatus in accordance with the modified embodiment of the invention shown in FIG. 21 showing the orientation thereof relative to a partially prefabricated shower pan floor.

FIG. 23 is a cross-sectional side elevational view of the assembled shower or bath drain apparatus in accordance with the modified embodiment of the invention shown in FIG. 21 installed with a partially prefabricated shower pan floor, waterproof membrane/liner and floor covering.

### DETAILED DESCRIPTION OF EXEMPLARY EMBODIMENT(S)

Before describing in detail exemplary embodiments that are in accordance with the present invention, it should be observed that the embodiments reside primarily in combinations of structural components and installation and use steps related to implementing apparatus and methods for a drain comprising a drain body which defines a drain aperture which is adapted to be placed in registry with a floor or other drain conduit in such a manner as to be sufficiently recessed within or below (i) a prefabricated shower pan floor, (ii) the floor of a partially prefabricated shower pan, (iii) a mortar bed or other hand made shower pan floor, (iv) a tiled or tileable surface or fixture, to accommodate a drain top, grate, or cover. A drain top, grate, or cover, which can be covered with stone, tile or other floor or wall coverings is associated with the drain body in such a way that (i) it covers all or a portion of the drain body so that the drain top, grate or cover is substantially coplanar with the untiled floor surface of (a) a prefabricated shower pan floor, (b) a partially prefabricated shower pan, (c) a mortar bed or other hand made shower pan floor, (d) a tiled or tileable surface or fixture; (ii) both the drain top, grate or cover and the surface surrounding or adjacent to the drain top, grate or cover can be covered with tile, stone, or other floor or wall covering, so that they will blend into the flooring material used on the area surrounding or adjacent to the drain top, grate or cover; (iii) the drain top, grate or cover is attachable to the drain or the area surrounding the drain top, grate or cover; (iv) the drain top, grate or cover may be removable and/or interchangeable with other drain tops, grates and covers; (v) the drain top, grate or cover permits water to drain into and though the drain apparatus along the grate free outside perimeter edge(s) of the drain top, grate or cover and/or the drain apparatus; (vi) the drain top, grate or cover is sized and shaped to create a grate free gap between the outside perimeter edges of the drain top, grate or cover and/or the drain apparatus and one or more of the tiled or untiled perimeter edges or surfaces of the area surrounding the drain top, grate or cover to permit water to drain into and though the drain apparatus; (vii) the drain top, grate or cover also permits water or other liquid to drain in a gap created when the drain cover is placed in registry with the drain body, such that the peripheral edge(s) of the drain cover is spaced from the drain recess peripheral sidewall so as to define a gap therebetween through which water or other liquid may pass while flowing toward the drain aperture; (viii) the drain is sufficiently recessed into or below an upper surface of (A) a prefabricated shower pan, or (B) a partially prefabricated shower pan, or (C) a mortar bed or other hand-made shower pan floor, or (D) a tiled or tileable surface or fixture, so that an upper surface of the tiled or tileable drain top, grate, or cover when attached in substantial registry with the drain is substantially coplanar with the adjacent tileable or tiled upper surfaces of (A) a prefabricated shower pan, or (B) a partially prefabricated shower pan, or (C) a mortar bed or other hand made shower pan floor, or (D) a tiled or tileable surface or fixture, and the lower surface of the attached drain top, grate or cover and the upper surface of the drain body floor are spaced so that a gap is created which is sufficient to allow for water to drain therethrough into the drain aperture, (ix) the drain top, grate or cover substantially covers the entirety of the drain aperture and the drain apparatus from view while permitting water to drain into and through the drain apparatus and drain aperture, and (x) a removable strainer can be part of the drain top, grate or cover, or placed between the drain top, grate or cover and the drain body and/or the drain aperture.

Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements.

The terms “comprises,” “comprising,” “comprise” or any other variation thereof are intended to cover a non-exclusive inclusion, such that a process, method, article, or apparatus that comprises a list of elements does not include only those elements, but may include other elements not expressly listed or inherent to such process, method, article, or apparatus.

The term “plurality of” as used in connection with any object or action means two or more of such object or action.

A claim element proceeded by the article “a” or “an” does not, without more constraints, preclude the existence of additional identical elements in the process, method, article, or apparatus that includes the element.

Terms such as “wall or flooring material,” “floor and wall coverings” and “covering material” mean, encompass and comprise one or more of ceramic, natural stone or other tile, stone, granite, marble, cultured marble, or other stone surface, non slip finished shower surfaces such as vinyl or plastic, stucco, concrete and mortar surfaces which may be mixed with adhesives or other substances, and any other material or materials used to provide a finished surface.

The term “tiled” means, encompasses, and comprises any surface having floor or wall covering materials, such as one or more of ceramic, natural stone or other tile, stone, granite, marble, cultured marble. or other stone surface, non slip finished shower surfaces such as vinyl or plastic, stucco, concrete and mortar surfaces which may be mixed with adhesives or other substances, and any other material or materials used to provide a finished surface.

The term “non tileable” means, encompasses, and comprises one or more surfaces or structural components which are not capable of receiving wall or floor material or were not designed, marketed or sold with the intention of being tileable or tiled, and in fact are not tiled.

The term “tileable” means, encompasses, and comprises one or more surfaces or structural components which are capable of receiving wall or flooring material, whether through the use of adhesives or any other means of attachment, such as clips, straps or other mechanical fastening structure(s).

The term “prefabricated shower pan” means, encompasses, and comprises any manufactured or fabricated tileable or tiled shower pan to which floor or wall coverings are to be adhered and that has one or more drains integrally associated into it at the time of manufacture or fabrication, and may also have integrated therein at the time of manufacture or fabrication a partial or complete floor (which may be pitched), a splash wall, a curb, and/or a barrier free entrance.

The term “partially prefabricated shower pan” means, encompasses, and comprises any manufactured or fabricated tileable or tiled shower pan to which floor or wall coverings are to be adhered, that does not have a drain integrally associated into it at the time of manufacture or fabrication, including (A) a manufactured or fabricated one piece shower pan with component elements such as a floor, a splash wall, a curb and/or a barrier free entrance integrated at the time of manufacture, or (B) a manufactured or prefabricated multi piece shower pan kit or set which when assembled and installed in the field comprises a one piece or multi-piece shower floor and which may include one or more component elements such as a splash wall, pitched floor, a curb, a barrier free entrance, or portions thereof, and, in either case A or B above, the drain is installed in the floor of the shower pan at any time after manufacture and prefabrication, usually in the field and/or at or around the time of assembly and installation of the shower pan.

Terms such as “mortar bed or other hand-made shower pan floor” and “mortar bed and shower pan” mean, encompass and comprise a shower floor, bath floor, a shower pan, a shower base, floor or other surface that is partially of fully formed by a bed of mortar or like material installed in the field or elsewhere on any substrate, including but not limited to concrete, wood, or steel, into which, in conjunction with, or below which, a drain is installed, and the mortar bed may be waterproofed using a vinyl liner, a membrane liner, hot mopping, or otherwise waterproofed, and floor or wall coverings are or may be adhered to the surface of the mortar bed.

Terms such as “tiled and/or tileable surface or fixture” and “surface or fixture” mean, encompass, and comprise any fully or partially tiled and/or tileable bathtub, bathroom floor, shower floor, sink, fountain, fixture, floor, or other surface that has a drain.

The term “non tileable and/or untiled surface” means, encompasses or comprises a surface such as a floor, wall, shower floor, bath floor, sink, shower pan, or any other surface which has a drain integrated or associated with it, and such surface is not tileable, nor is it designed to be tiled or tileable, and/or such surface is in fact not tiled.

The term “drain” means, encompasses and comprises any kind of drain made of any kind of material, including but not limited to metal or plastics, and with any kind of connection to a drain system such as a waste water system, including but not limited to a trench drain, a solvent weld drain, a welded connection drain, a hub (outside caulk) drain, a spigot drain, a hubless spigot drain, a hubless drain, an inside caulk (gasket) drain, a hubbed (push on) drain, a compression drain, and a clamping ring drain.

Terms such as “drain top, grate or cover” and “drain cover” mean, encompass and comprise anything that covers all or a portion of a drain, whether it is manufactured as part of the drain or is separately made and placed over or on top of all or a part of the drain, and whether it is one piece or multiple pieces which in combination cover all or a portion of the drain, and such drain top, grate or cover may be made out of one or materials, including but not limited to metals, such as cast iron, copper, steel, aluminum, plastics such as PVC or ABS, polyurethane, polyethylene, building products such as stone, tile, concrete, marble, cultured marble, mortar, stucco or the like, or any other material suitable as a drain top or cover.

A “drain body” means, encompasses and comprises preformed drain bodies and other areas into which liquids may otherwise drain, such as depressions in a shower, bath, basin or bathroom floor, whether preformed or formed during the assembly of the shower, bath, basin or floor.

The term “grate free” means any area over, near or in registry with a drain into which water or other liquid may drain which is substantially free of obstruction.

The inventions disclosed herein may be employed in sinks, basins, showers, baths, shower pans, fixtures, and any other surface or fixture that has a drain.

The present invention is directed to shower pans, drains and drain tops, grates or covers which are used independently or in combination with (i) a prefabricated shower pan, (ii) a partially prefabricated shower pan, (iii) a mortar bed or a hand made shower pan floor, and/or (iv) a tiled or tileable surface or fixture, and which drain tops, grates or covers at least partially cover the drain apparatus, where the drain cover is tileable, attachable, (optionally) removable and interchangeable with other tileable or non tileable drain tops, grates or covers which permit water to drain through a gap between the tiled or tileable drain top, grate or cover and the tiled or tileable area surrounding and/or adjacent to the drain top, grate or cover, while substantially concealing the drain apparatus and the drain aperture, and method of installation and use.

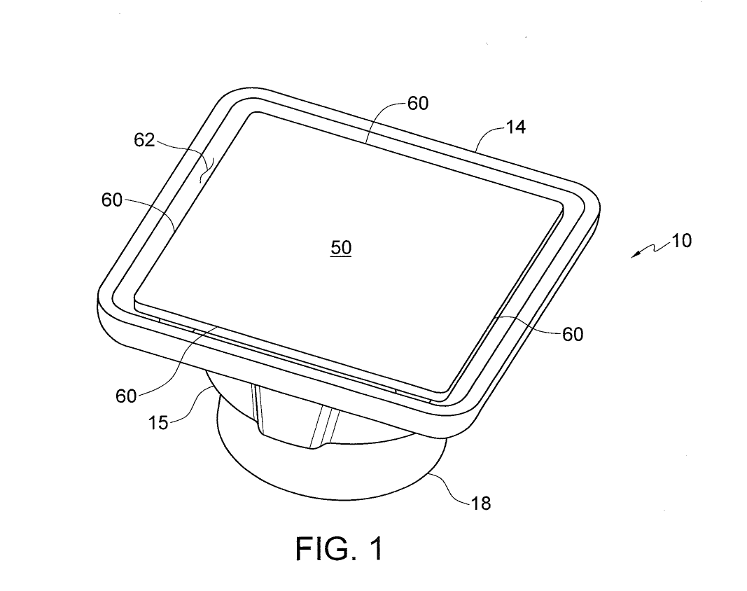

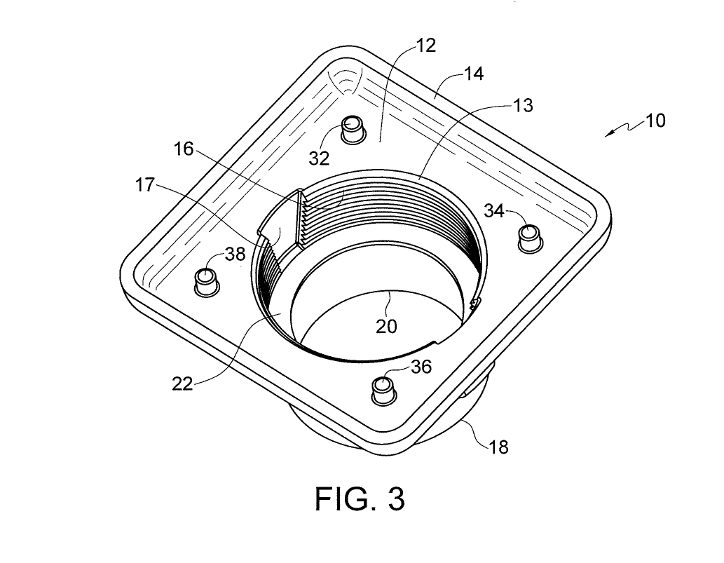

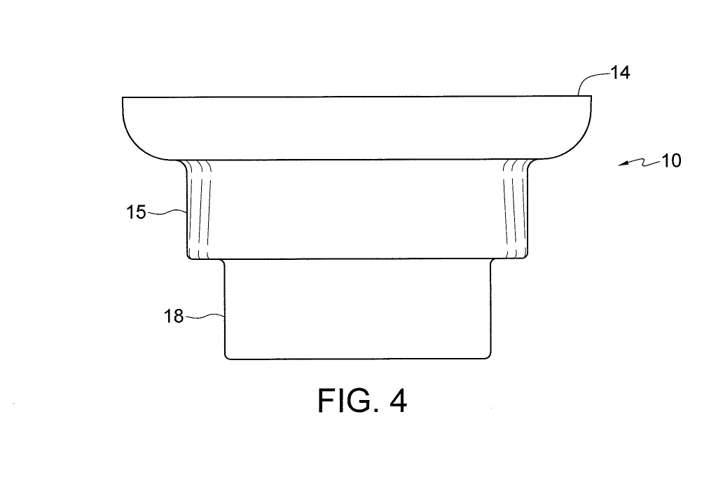

As best shown in FIGS. 1-5, a preferred embodiment of the invention comprises a drain body 10 adapted to be connected to a (i) a prefabricated shower pan, (ii) a partially prefabricated shower pan, (iii) a mortar bed or other hand made shower pan floor, (iv) a tiled or tileable surface or fixture, or other shower, shower pan, bath or sink floor, fixture, or floor of any type, for example a conventional prefabricated waterproof shower or bath pan of the type disclosed in U.S. Pat. No. 5,913,777. The drain body 10 may be connected to (i) a prefabricated shower pan, (ii) a partially prefabricated shower pan, (iii) a mortar bed or other hand made shower pan floor, (iv) a tileable or tiled surface or fixture, by any suitable means, including but not limited to, being integrally molded therewith during manufacture thereof, by connection post-manufacture, or in situ in field. The shape of drain body 10 is shown as rectangular in the drawings. However, it is to be appreciated that drain body 10 may be made in any desired shape without departing from the spirit or scope of the invention. In addition, any number of drain structures of this invention may be employed in any given application.

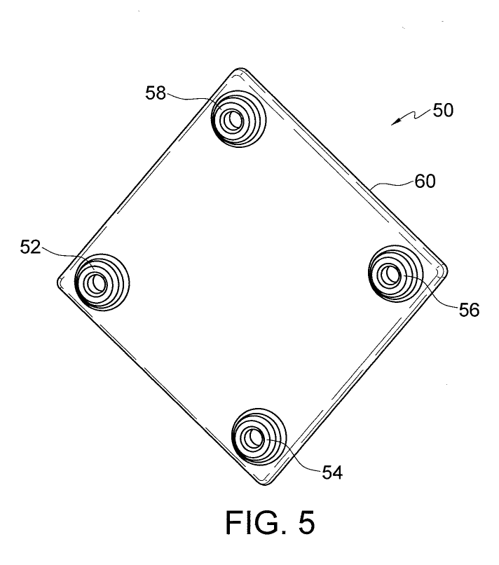

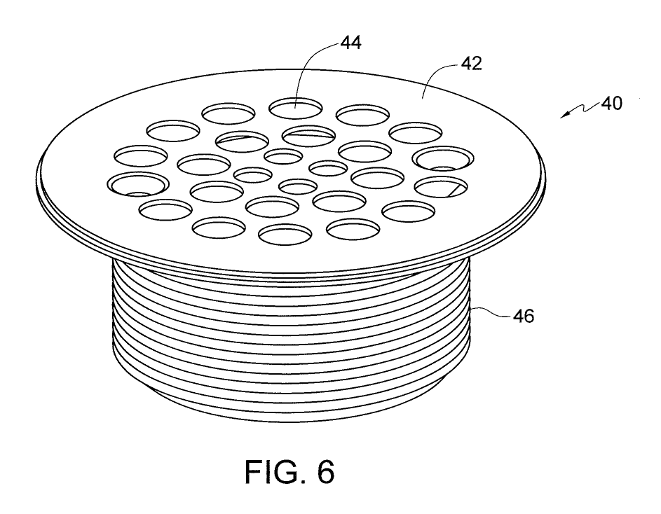

The drain body 10, in its simplest and preferred form as shown in FIGS. 1-5, is comprised of a waterproof structure having a floor section 12 which defines a drain aperture 13, and a peripheral sidewall section 14. Structure for releasably and interchangeably attaching a drain top, grate or cover 50 to drain body 10 is employed, such as posts 32, 34, 36 and 38 which are adapted to mate with corresponding sockets 52, 54, 56 and 58 on a drain cover 50. Alternatively, cover 50 may releasably and interchangeably attach to drain body 10 by any other connection structure, such as by more or fewer posts and sockets, different connection structure, or by being attached to and made part of the threaded drain insert 40 (shown in FIGS. 5-6), which includes a threaded collar 46 which is adapted to threadingly engage threaded surface 16 of drain collar 15, or by any other manner which will occur to those of skill in the art. Alternatively, cover 50 may attach to the shower or bath pan floor. Corresponding connection structure may be employed in association with the shower or bath pan floor, such as connection posts or sockets similar to those described elsewhere in this disclosure, or any other structure for connecting cover 50 to the floor which will occur to those of skill in the art.

Drain body 10 may, preferably but not by way of limitation, include a depending collar section 15, the inside surface 16 of which is threaded. Drain body 10 may also preferably but not by way of limitation include a further depending collar section 18 which is adapted to engage the interior of a drain pipe (not shown) of a building's plumbing lines. Drain body 10 may have one or more of the many types of connections, for example (i) from the drain body to the waste water system; and (ii) from the drain body to the drain top, grate or cover, including without limitation a threaded connection, a hub connection, a no hub connection, a solvent weld connection, a compression drain connection, a trench drain, a welded drain connection, an outside caulk drain connection, an inside caulk drain connection, a spigot drain connection, a hubless spigot drain, a hubless drain, inside caulk(gasket) drain, hubbed (push on) drain, a compression drain, a clamping ring drain, etc.

Cover 50 is defined by peripheral edge 60, which, again, may be manufactured in any desired shape, and is adapted to cover a portion of drain body floor 12 so as to permit a tileable surface above the drain and the drain aperture while simultaneously concealing the drain aperture 13, the drain, and as much of floor 12 as is practicable and still have the required grate free area for adequate drainage. When cover 50 is connected to drain body 10, peripheral edge 60 of cover 50 is spaced from sidewall 14 so as to define a gap or grate free area G there between through which water may pass while flowing through the drain and toward drain aperture 13. In this way, water is permitted to exit the shower, bath, sink or other such area without the drain aperture or drain 13 being visible. Likewise, the peripheral edge 60 also forms a gap with drain body floor 12.

The drain apparatus of this invention is preferably utilized as part of (i) a prefabricated shower pan, (ii) a partially prefabricated shower pan, (iii) a mortar bed or other hand made shower pan floor, and/or (iv) a tiled or tileable surface or fixture, whereby flooring or wall material such as tile may be attached up to (i.e. adjacent) or upon peripheral wall 14 by epoxy, concrete, or any suitable wall or flooring adhesive, and additional flooring or wall coverings, if any, placed upon drain cover 50 with an appropriate wall or flooring adhesive. In this way, the drain top, grate or cover has a finished tiled look which matches the area surrounding or adjacent to the drain top, grate or cover, with the drain and drain aperture fully operational yet unnoticeable.

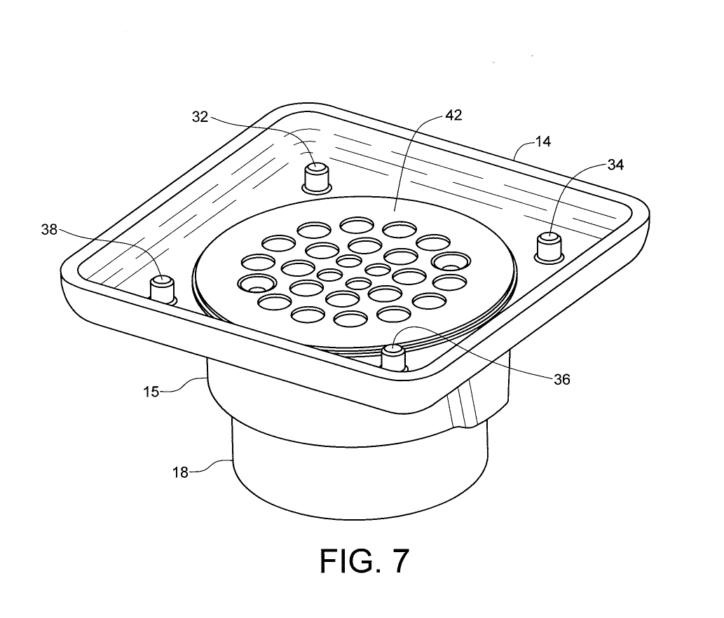

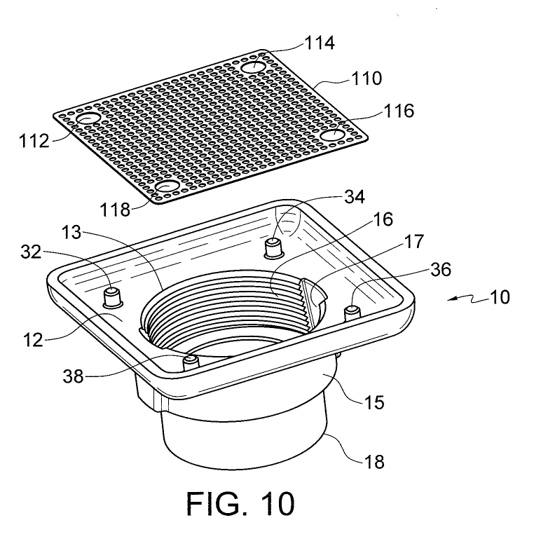

A strainer made of any appropriate material, an example of which is shown in FIG. 10, may be placed on drain floor 12 so as to cover drain aperture 13, which strainer is intended to catch any debris which would flow through the grate free area (i.e. gap G) and which would otherwise flow into the drain aperture 13 but for the strainer. The strainer may be held in place by nesting apertures 112, 114, 116 and 118 with lugs or posts 32, 34, 36, and 38, or by any other appropriate structure occurring to one with skill in the art, and will be accessible by removing the drain top, grate or cover 50 for purposes of cleaning or replacing. Alternatively, any of the standard types of strainers, such as that shown in shown in FIGS. 6-7, may be employed.

To that end, a drain insert 40 may be employed in connection with drain body 10 as shown in FIGS. 6-9. Insert 40 may include a threaded collar 46 which is adapted to threadingly engage threaded surface 16 of drain collar 15. Insert 40 may also include one or more interchangeable drain tops, grates or covers, such as drain grate 42, which defines one or more drainage apertures or grate free areas 44. The drain grate with grate free areas may be provided with any type of finish and/or any number of custom designs. The drain assemblies of this invention may also be provided with interchangeable drain grates with any imaginable configuration(s) for the grate free area.

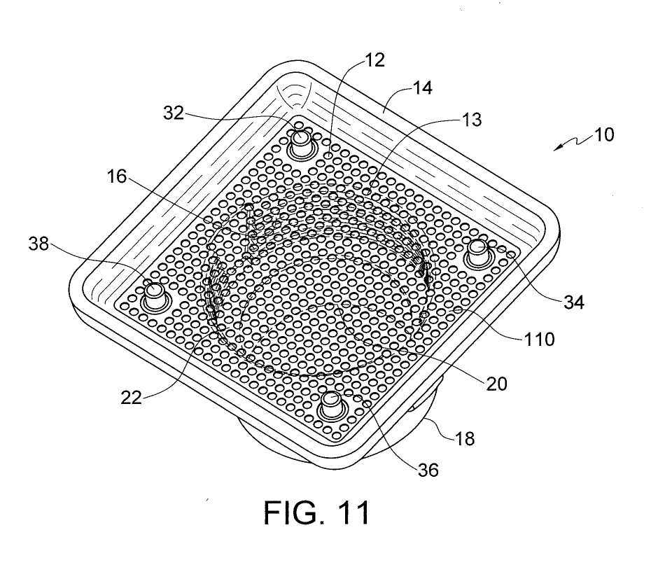

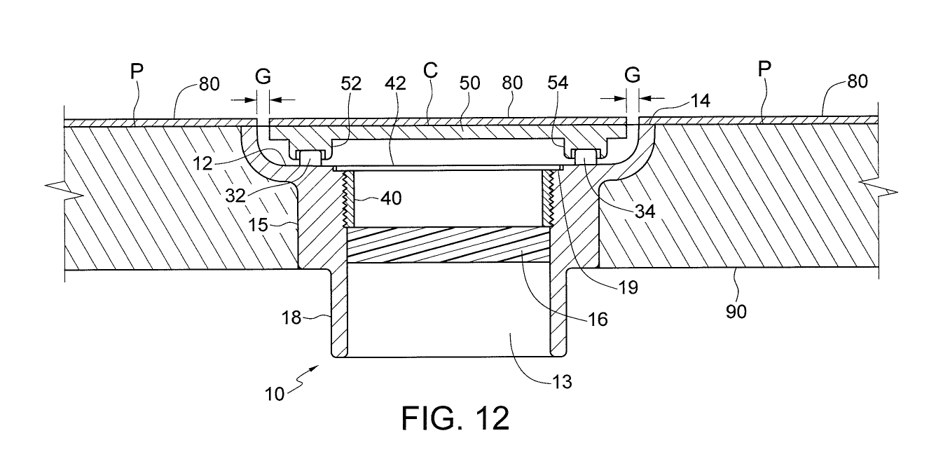

Alternatively, as shown in FIGS. 11-12, a strainer 110 may be employed which, rather than being connected to a separate insert such as drain insert 40, may be placed in registry with drain aperture 13. As discussed above, strainer 110 may have disposed therein apertures 112, 114, 116 and 118 adapted to fit over posts 32, 34, 36 and 38. Alternatively, a strainer such as strainer 110 may simply be placed upon floor 12 or connected or otherwise positioned in registry therewith by any means known to the artisan, such as by attachment to strainer body 40.

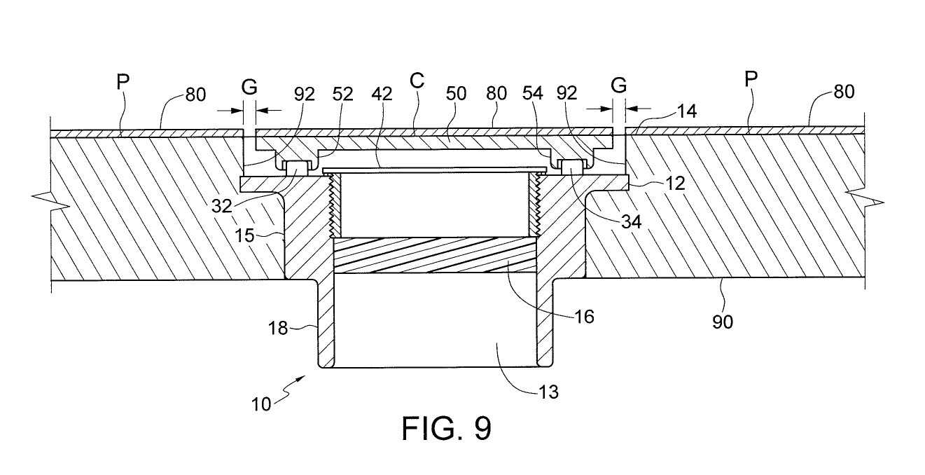

Drain body 10 need not necessarily employ a sidewall section 14. Rather, as the exemplary embodiment of FIG. 9 shows, the shower or floor pan or other structure which functions as the shower, bath, sink or other floor substrate may provide the sidewall structure needed to constrain water flowing toward the floor drain. In this case, drain body 10 need only be comprised of a floor section 12. Once combined with the shower or bath pan or other structure which functions as the shower, bath, sink or other floor substrate, drain body 10 will be situated within the pan in such a way that a drain plenum is formed by the drain body floor section 12 and the sidewalls 92 which form the drain recess into which the drain body 10 has been positioned.

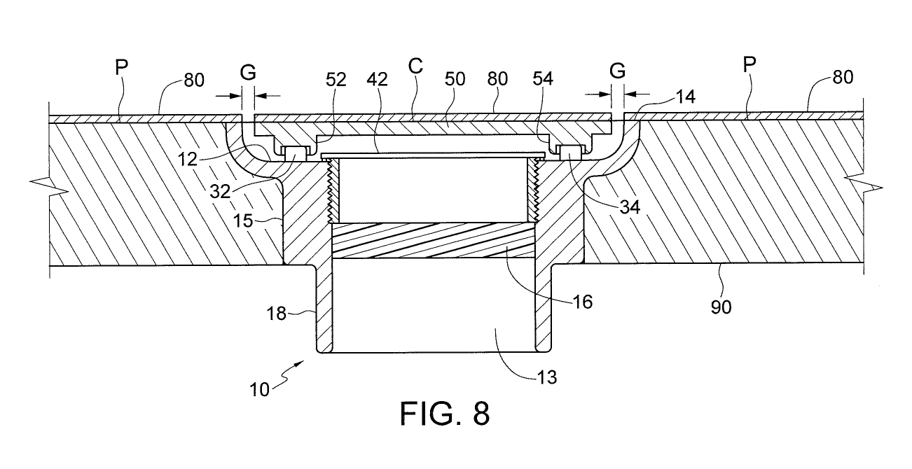

In such an embodiment, in all other respects the drain apparatus is the same as described elsewhere herein. That is, a drain top, grate, or cover 50 may be removably connected to drain body 10 in any suitable manner, such as by the use of one or more posts 32, 34, 36 and 38 which coact with corresponding recesses 52, 54, 56 and 58 in cover 50. As can be seen in FIG. 8, drain body floor 12 and sidewalls 14 form a plenum into which water drains from the shower, bath, sink or other floor, which in turn drains into drain aperture 13. Likewise, as seen in FIG. 9, drain body floor 12 and sidewalls 92 form a similar plenum. Likewise, drain body 10, whether with or without sidewalls 14, will form a similar drain plenum when combined with floor or other substrates formed by (i) a prefabricated shower pan, and/or (ii) a partially prefabricated shower pan, and/or (iii) a mortar bed or other hand made shower pan floor, and/or (iv) a tiled or tileable surface or fixture, whether such substrate is constructed on site in whole or in part.

As stated above, the shower, sink, bath, floor or other surface or structure which functions as the shower, bath, sink, floor or other substrate, may be of any type, such as (i) a prefabricated shower pan, (ii) a partially prefabricated shower pan, (iii) a mortar bed or other hand made shower pan floor, and/or (iv) a tiled or tileable surface or fixture.

It is to be understood that the posts and sockets may be reversed in whole or in part, such that any of the posts may be connected to cover 50, and any of the sockets may be connected to drain body 10. The post and socket arrangement disclosed herein is but an example of the many ways in which drain top, grate, or 50 may be associated with the drain or drain body 12, it being appreciated that any suitable attachment arrangement is contemplated to be within the scope of this invention.

The invention is also directed to a method of installing a tileable drain assembly over a drain or over another area that drains into a drain or a drain aperture which has a grate free area adjacent to one or more perimeter edges of a drain top, grate, or cover 50 in accordance with this invention, which includes the steps of: (1) connecting a drain body 10 of this invention to a prefabricated shower pan, a partially prefabricated shower pan, a mortar bed or other hand made shower pan floor, and/or a tiled or tileable surface or fixture, the drain body 10 defining at least one drain aperture 13 and optionally including a peripheral sidewall 14 and, (2) installing the floor pan in a shower or bath enclosure space (not shown) so that the drain aperture 13 is substantially in registry with an existing floor drain; (3) providing a drain top, grate or cover 50 which is sized and shaped, when connected to the drain body 10, to provide a grate free area or gap G between a peripheral edge 60 of the drain top, grate or cover and the drain body sidewall 14 (and/or the adjacent prefabricated shower pan, partially prefabricated shower pan, mortar bed or other hand made shower pan floor, and/or a tiled or tileable surface or fixture) to permit drainage of water through said gap G.

Another method of installing a tileable drain assembly over a drain or over another area that drains into a drain or a drain aperture which has a grate free area adjacent to one or more of the perimeter edges of a drain top, grate, or cover 50 in accordance with this invention includes the steps of: (a) connecting a drain body 10 of this invention to a floor drain, the drain body including a peripheral sidewall 14; (2) installing flooring material onto the adjacent shower, bath, sink or other floor in the vicinity adjacent the peripheral sidewall of the drain body; (3) providing a removable drain cover which is sized and shaped, when connected to the drain body, to provide a gap G between the drain body sidewall and the peripheral edge of the drain cover to permit drainage of water through said gap; and (4) installing flooring material on the drain cover.

Yet another method of installing a tileable drain assembly over a drain or over another area that drains into a drain or a drain aperture which has a grate free area adjacent to one or more of the perimeter edges of a drain top, grate, or cover 50 in accordance with this invention includes the steps of: (1) connecting a drain body of this invention substantially in registry with an existing floor drain; (2) providing a removable drain cover which is sized and shaped, when connected to the drain body, to provide a gap G between the drain body sidewall and a peripheral edge of the drain cover to permit drainage of water through said gap G.

A still further method of installing a tileable drain assembly over a drain body or over another area that drains into a drain or a drain aperture which has a grate free area adjacent to one or more of the perimeter edges of a drain top, grate, or cover 50 in accordance with this invention includes the steps of: (1) installing one or more of (a) a prefabricated shower pan, (b) a partially prefabricated shower pan, (c) a mortar bed or other hand made shower pan floor, (d) a tiled or tileable surface or fixture, in a shower or bath enclosure space (not shown), each of the prefabricated shower pan, partially prefabricated shower pan, mortar bed or other hand made shower pan floor, or tiled or tileable surface or fixture including a floor, so that the existing floor drain is substantially in registry with a location on the floor where a hidden shower or bath drain in accordance with the teachings of this invention is to be employed; (2) connecting a drain body 10 of this invention to the prefabricated shower pan, partially prefabricated shower pan, mortar bed or other hand made shower pan floor, or tiled or tileable surface or fixture by creating an aperture in said prefabricated shower pan, partially prefabricated shower pan, mortar bed or other hand made shower pan floor or tiled or tileable surface or fixture into which is adapted to be attached the drain body 10, the drain body 10, optionally including a peripheral sidewall 14, and defining at least one drain aperture 13; (3) providing a drain cover 50 which is sized and shaped, when connected to the drain body 10, to provide a gap G between the drain floor 12 and/or drain body sidewall 14 and a peripheral edge 60 of the drain cover to permit drainage of water through said gap G.

In use, when the drain apparatus of the instant invention is connected to (i) a prefabricated shower pan, (ii) a partially prefabricated shower pan, (iii) a mortar bed or other hand made shower pan floor, and/or (iv) a tiled or tileable surface or fixture, cover 50 may be removed to permit access to aperture 13 and/or to permit installation of insert strainer 40 or any other strainer such as strainer 110 shown in FIGS. 10-11 for cleaning and/or maintenance. Also, the building plumbing may be rooted out without requiring removal of drain body 10 so long as cover 50 is removed. When cover 50 is installed upon drain body 10, it is intended to be virtually impossible to detect that a drain is even present.

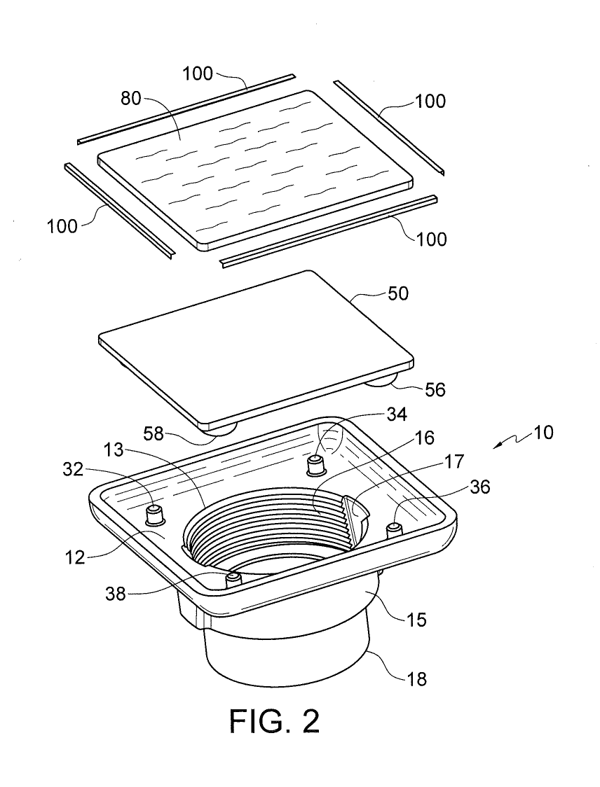

A representative, non-exhaustive, depiction of a type of flooring material which may be used with the invention is shown in FIGS. 2, 8-9 and 11-12 in the form of one or more pieces of flooring tile 80. As stated above, floor or wall covering material suitable for use with this invention may be one or more of ceramic, natural stone or other tile, stone, granite, marble, cultured marble, or other stone surface, non slip finished shower surfaces such as vinyl or plastic, stucco, concrete, and mortar surfaces which may be mixed with adhesives or other substances and any other material or material used to provide a finished surface. As seen in FIGS. 8-9, once flooring material 80 is installed in the shower or bath pan 90 up to the area adjacent to the outer peripheral edge 14 of drain body 10 or pan interior sidewalls 92, and installed on top of cover 50, the upper surface C of which is designed to be coplanar with the upper surface P of the adjacent area of the shower or bath pan (or mortar bed floor) 90, a contiguous finished shower or bath surface is formed, and the drain is essentially undetectable.

In addition, the drain body may be employed without the use of a cover such as cover 50 in which case no flooring material will be used to conceal the actual drain aperture or strainer insert 40, or may employ a differently configured cover which acts as an unconcealed drain top, grate or cover. (i.e. that is not covered with flooring material). The drain body may be installed in or below the upper surface of (i) a prefabricated shower pan, (ii) a partially prefabricated shower pan, (iii) a mortar bed or other hand made shower pan floor, (iv) a tiled or tileable surface or fixture. In this way, a provider of products of this type may significantly reduce attendant manufacturing costs by reducing the number of molds employed in the manufacture of a variety of pan sizes. In addition, management of inventory is simplified since a single drain body 10 may be used for all prefabricated or manufacture products having a drain, and while using interchangeable tileable, non tileable, and designer drain tops, grates or covers to establish separate product lines which can be marketed and sold based on the finish of the drain top, grate or cover. Alternatively, the different drain tops, grates or covers can be supplied as part of a kit, or as accessories which can be ordered or otherwise purchased separately, allowing for a wide variety of combinations of tiled, tileable or non tileable drain tops, grates or covers, with concealed or unconcealed drains, with designer tops, including but not limited to, (i) a tileable drain top, grate or cover with a concealed drain, (ii) a non tileable drain top, grate, or cover with a standard grate free area design, and an unconcealed drain, (iii) a non tileable drain top, grate or cover with a designer drain top, grate or cover and an unconcealed drain, or (iv) an unconcealed drain and an untiled designer drain top, grate or cover, simply by substituting one drain top grate or cover for another, i.e., removing the tileable cover 50 and connecting any number of different tileable or non tileable drain tops, grates or covers over drain aperture 13.

FIGS. 10-11 and 14 show a strainer insert 110 adapted to be placed onto floor 12. Strainer 110 defines apertures 112, 114, 116 and 118 which are adapted to receive posts 32, 43, 36 and 38. Alternatively, strainer 110 may be of any size or shape, so long as it effectively covers drain aperture 13.

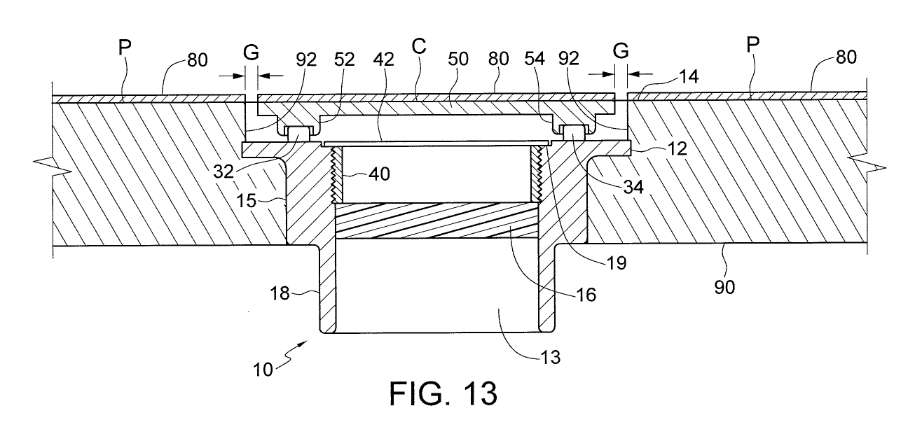

FIGS. 12-13 show a modified drain insert assembly, whereby floor 12 of drain body 10 is recessed around drain aperture 13, creating an annular recess or shoulder 19 into which strainer 42 of drain insert 40 may be nested, so as to create a smooth transition for water flowing from floor 12 into drain aperture 13. Alternatively, a stand alone strainer such as that shown in FIGS. 10-11, preferably, but not by way of limitation, round shaped, may be dropped into the annular recess defined by shoulder 19 and attached thereto by any suitable means.

The exposed edges of cover 50 and/or flooring material 80 around gap G may be covered, beveled, ground or otherwise rendered smooth so that it will not expose a user to any sharp edge which may injure the user. Adhesively or clip-on attachable L-shaped cover members 100 may be provided, by way of additional example, so as to cover the edges of cover 50 and/or flooring material 80. Alternatively, a flowable, hardenable material such as liquid epoxy, or other resinuous or plasticized material may be poured or otherwise coated over the exposed edges.

Cover 50 may be, as stated above, removable, and additional and/or replacement covers may be provided or sold separately to permit variation in the appearance of the drain and/or shower, bath, tub or basin. For example, a user may wish to use a first covering material such as floor or sink/tub/basin tile on a first cover member 50, and a second, different, covering material on a second cover member 50. Additional replacement cover members 50 may be provided with still further covering materials associated with them. For example, a user may wish to employ a decorative covering material on one cover member 50, and his or her favorite sports team or celebrity on another, or a builder or hotelier may wish to have a unique feature or logo tiled onto the drain top, grate or cover, and so forth.

However, it is also to be understood that cover 50 may be connectable to drain body 10 in a manner that will preclude the removal thereof once connected. Also, drain body 10 and cover 50 may be manufactured as an integral unit.

It is to be understood that the drain assembly disclosed herein may be employed without the prefabricated shower pan or partially prefabricated shower pan referenced above. Drain body 10 may be installed in a mortar bed or other hand made shower pan by creating a mud or mortar base for a shower, tub, etc., placing drain body collar section 18 in registry with a floor or basin/sink drain while sinking drain body 10 into said mud or mortar base, and tiling over or up to the outer periphery of the drain body 10. One or more covers 50 may then be interchangeably employed in the manner discussed above.

It is also to be understood that the cover members 50 of this invention may be of any shape or size. Drain body 10 may or may not be correspondingly shaped as well.

Drain assemblies in accordance with this invention may be located at essentially any position within a (i) a prefabricated shower pan, (ii) a partially prefabricated shower pan, (iii) mortar bed or other hand-made shower pan, and/or (iv) a tiled or tileable surface or fixture. If the drain assembly is located near one or more sidewalls (if any) of such pan or bed, one or more of the gaps G surrounding the outer peripheral edges 60 of cover 50 may be bounded by the sidewall, such that the outer boundary of gap G along the edge of cover 50 facing the sidewall or sidewalls will be the sidewall or sidewalls. Or, the cover 50 and/or covering material 80 attached to cover 50 may be butted up against or in close proximity to said sidewall or sidewalls.

The drain cover may alternatively be attached to the drain apparatus through an attachment structure which allows the height of the upper surface of the drain cover to be positioned so that it is coplanar with an upper surface of the (A)prefabricated shower pan, (B) partially prefabricated shower pan, (C) a mortar bed or other hand made shower pan floor, or (D) a tiled or tileable surface or fixture, adjacent to the drain top, grate, or cover, such attachment structure including but not limited to: (i) attaching a drain insert such as insert 40 to the drain by threadingly attaching the drain, top, grate or cover to the drain insert, rotating the drain insert down to the appropriate height, and then attaching the drain top, grate or cover to the drain insert, by screws, clips, snap-on posts, or other suitable attachment mechanism or (ii) attaching the drain cover to posts on the drain body floor with variably sized spacers to allow the height of the non tileable drain cover to be coplanar with the tiled prefabricated shower pan adjacent to the non tileable drain top, grate, or cover, or (iii) any other method that allows the non tileable drain top, grate or cover to be adjustably attached to the drain cover apparatus at a height that is coplanar with the tiled prefabricated shower pan surface.

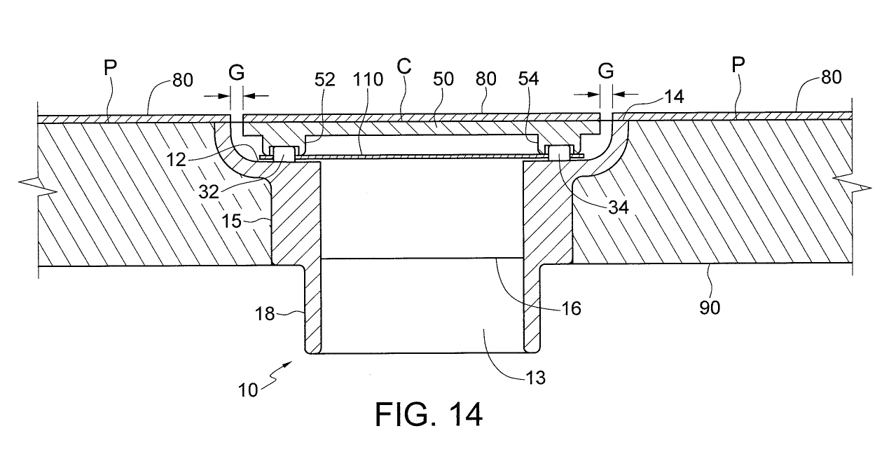

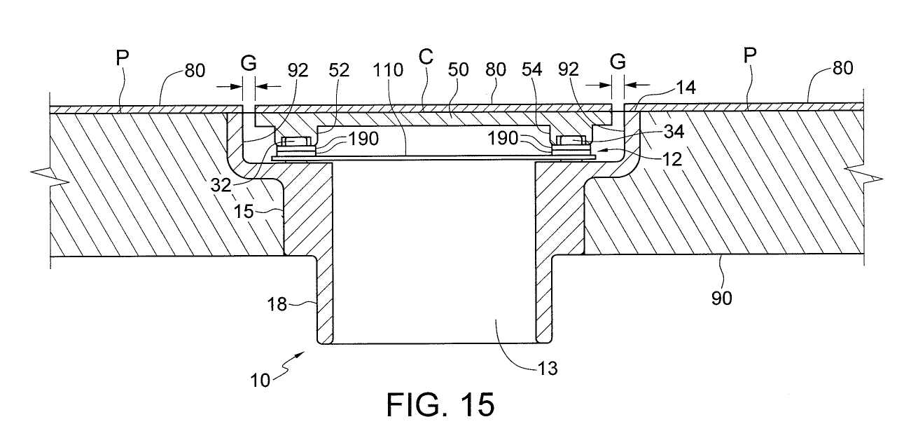

FIG. 15 shows spacers 190 being used between drain body floor 12 and the bottom of sockets 52, 54, 56 and 58, which permit the adjustment of the height of upper surface C of cover 50 and upper surface P of pan floor 90. In this way, the height of cover C relative to the adjacent pan floor can be adjusted to accommodate height variations in the drain body and pan assembly as well as variations, if any, in the thickness of floor covering material employed. It is to be understood that the configuration shown in FIGS. 14 and 15 may be likewise employed in the configuration shown in FIGS. 9 and 12-13.

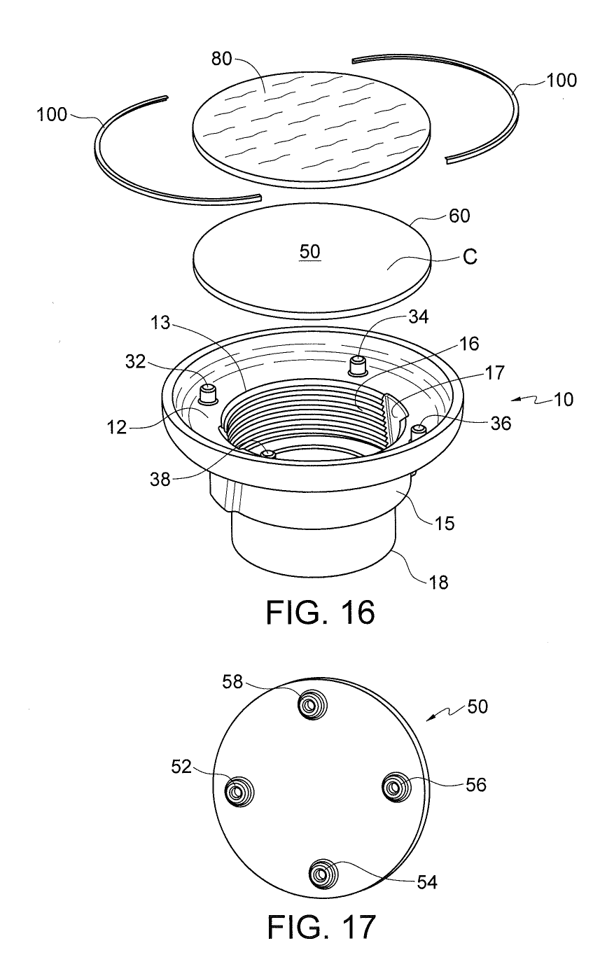

FIGS. 16-17 show an alternative configuration for the drain body and cover assembly. In this embodiment, drain body 10 and cover 50 are circular in shape. The invention otherwise functions in accordance with the principles described herein. Obviously, drain body 10 and/or cover 50 may be sized and shaped in any manner.

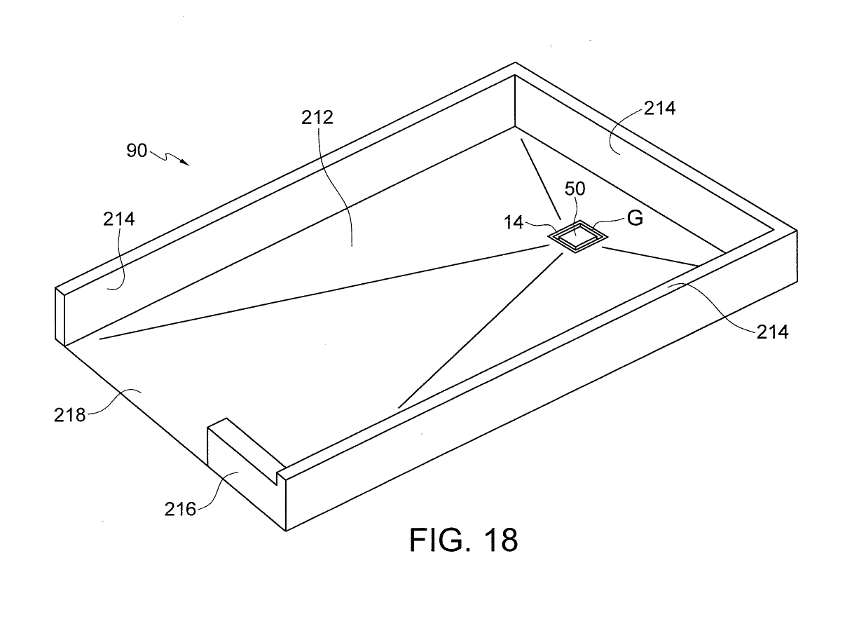

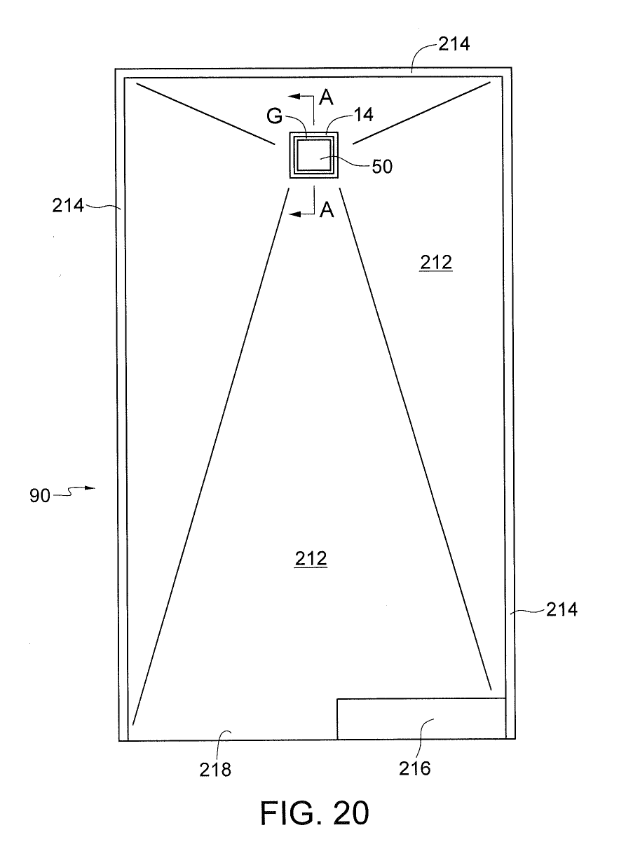

FIGS. 18-20 show a representative example of a prefabricated shower or bath pan in accordance with this invention having the drain body 10 of the instant invention associated therewith. Pan 90 may be comprised of a floor 212, sidewalls 214, a curb 216 and one or more barrier-free thresholds 218. Any other configuration of a prefabricated shower or bath pan known to those of skill in the art may be employed. Drain body 10 may employ sidewalls 14 as shown in FIG. 8, or be without sidewalls as shown in FIG. 9. Cover 50 is associated therewith, so as to form gap G through which water may drain.

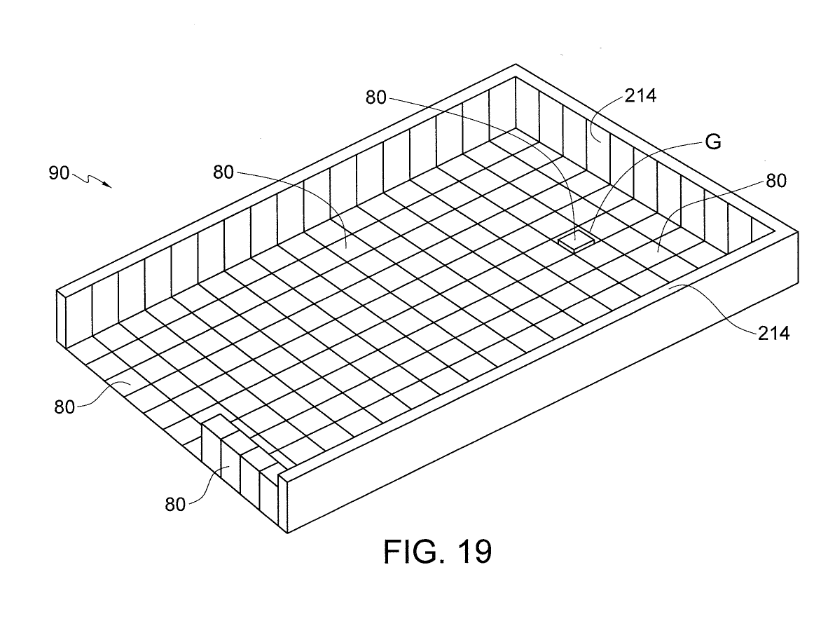

In this embodiment, one or more drain bodies, such as any of the drain bodies illustrated in FIGS. 1-17, are connected to pan 90, preferably during manufacture of pan 90. Pan 90 is installed within, or forms the space for, a shower enclosure. Tailpiece 18 of drain body 10 (shown in FIGS. 1-4 and 7-16) is placed in registry with the existing floor drain (not shown) during installation of pan 90. Pan 90 is otherwise installed as known to those of skill in the art. Wall or flooring material 80 is then installed over pan 90 and cover 50 as shown in FIG. 19.

In addition, the drain apparatus disclosed herein may also be employed with a partially prefabricated shower pan where the drain is installed in the shower pan floor after manufacture, usually in the field and at the time of installation of the partially prefabricated shower pan. Such a partially prefabricated shower pan may be comprised of any of the components shown in the pan of FIG. 18, or additional or fewer components, depending upon the needs of the application. Further additionally, the drain apparatus disclosed herein may also be used in conjunction with a mortar bed or other hand made shower pans, or any surface or fixture in which a drain is to be installed. In either installation, i.e. pans assembled and installed in the field (for example, partially fabricated shower pans, mortar beds or other hand made shower pan floors, and surfaces or fixtures into which one or more drains are to be installed), the drain body must be connected to the floor drain while at the same time being recessed within the shower pan floor so that upon completion of the installation, the tileable or tiled drain top, grate or cover will be coplanar with the tileable or tiled shower pan floor or other surface or fixture immediately adjacent thereto.

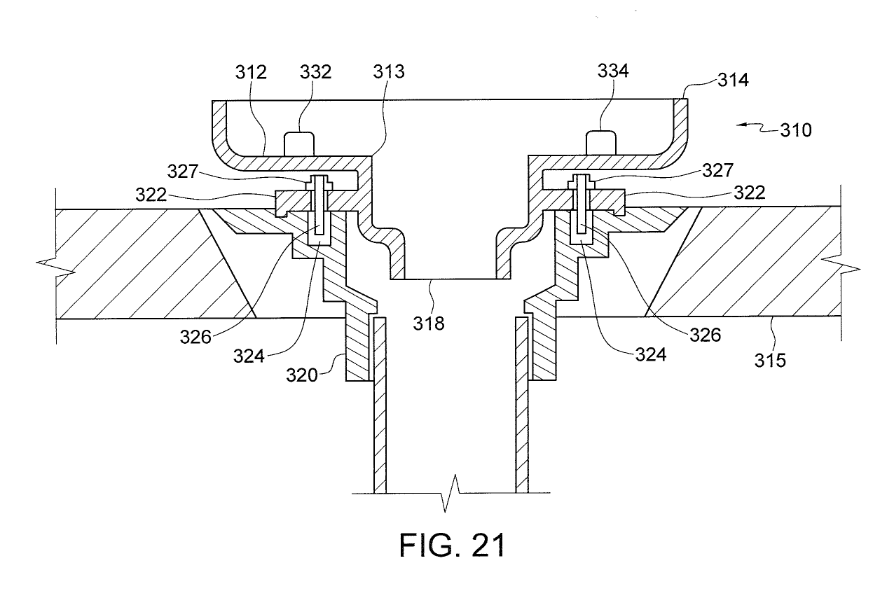

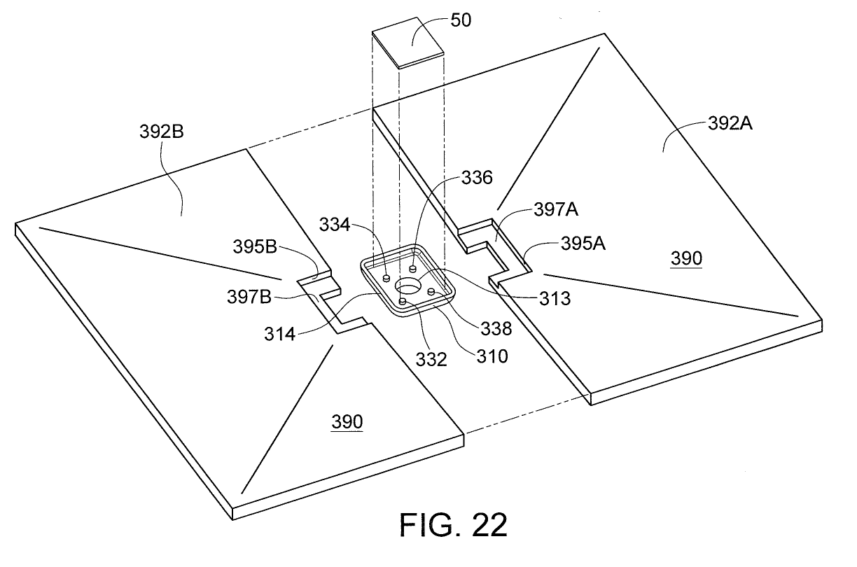

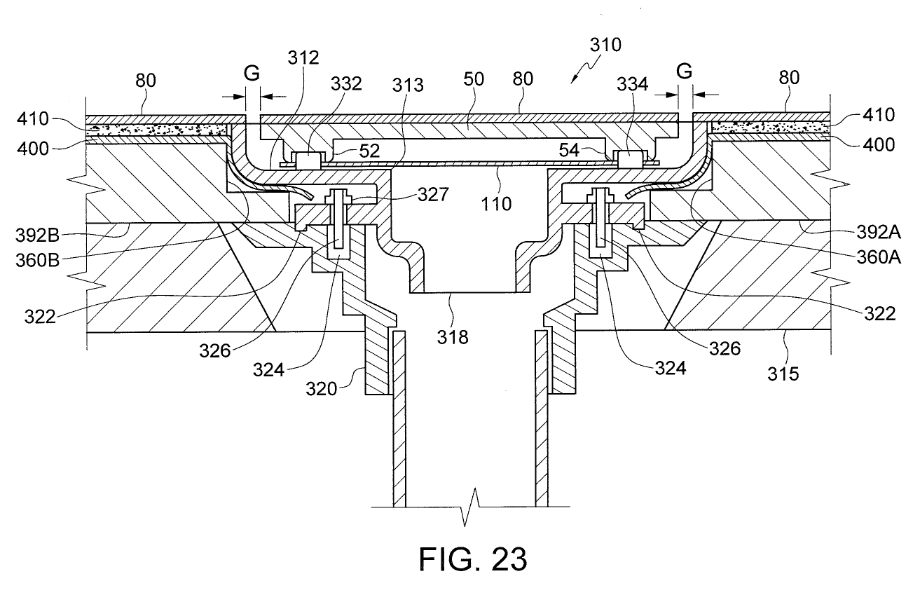

One manner of implementing such an arrangement is by the use of a modified drain body 310 shown in FIGS. 21-23. Drain body 310 may have a floor section 312 which defines a drain aperture 313, optional sidewalls 314, posts 332, 334, 336 and 338 for receiving corresponding sockets in cover 50, and a drain body tail piece 318, similar to that described in previous embodiments.

A floor mounting flange 322 is associated with drain body 310 in a manner which will be apparent from the description below. A standard floor drain collar 320 is adapted to be positioned within a subfloor 315, and has associated therewith one or more bolts 326 which are threadingly or otherwise connected to drain collar 320 in any manner which will occur to those of skill in the art. In the example shown, bushings 324 are retained by corresponding sockets in drain collar 320, which in turn receive threaded bolts 326. When drain body 310 is placed upon floor drain 320, apertures in flange(s) 322 are aligned with bolts 326, and retaining nuts 327 secured thereover to fasten drain body 312 to floor drain collar 320.

As best seen in FIGS. 21-23, in the event a partially prefabricated pan is to be employed to create the shower pan, a pan floor 390 may be employed which is made up of two or more sections or pieces 392A, 392B, which define corresponding cutouts 395A, 3958 which nest around the outer surfaces of drain body sidewalls 314. Areas of reduced thickness such as shoulders 397A, 397B defined by the sidewalls of cutouts 395A, 395B are slid between the substrate such as subfloor and/or thinset 315 and drain body floor 312 upon installation of pan floor sections 395A, 395B into an enclosure space such as a shower or bath enclosure. Thereafter, additional covering material such as a waterproof liner or membrane 400, and/or mortar or thinset or other setting materials and/or adhesives 410, and floor or wall covering material such as tile 80 over pan floor 392A, 392B and cover 50, may be installed to complete the installation. It is also understood that the partially prefabricated shower pan may have one piece shower pan floor, in which case a hole is cut into a shower pan floor for purposes of installing the drain and attaching it to the waste water system, and such partially prefabricated shower pan may also have additional component parts such as a curb, barrier free entrance, splash walls, and water proofing materials which are also assembled and installed in the field with the one piece shower pan floor.

A partially prefabricated pan such as the one disclosed herein may be installed by numerous methods, including the method which comprising the steps of: (1) connecting a drain body of this invention substantially in registry with an existing plumbing drain pipe; (2) providing a removable drain cover which is sized and shaped, when connected to the drain body, to create a gap between the drain body and a peripheral edge of the drain cover, to permit drainage of water through said gap.

This method may be embellished by the addition of the steps of: (3) providing a shower pan floor made of two or more sections, at least one of the sections defining a drain body-receiving cutout therein adapted to nest with the drain body; (4) placing the shower pan floor sections in registry with the subfloor such that the cutout(s) nests with the drain body; and (5) attaching floor or wall covering material on upper surfaces of the floor sections and an upper surface of the cover.

Any other manner and/or structure of connecting a drain cover to a wastewater drain pipe are contemplated to be within the scope of application of the apparatus and methods described herein. For example, the drain bodies shown and described herein are likewise suited for use with compression drain and clamping ring drain attachment arrangements.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made while this application is pending and all equivalents of those claims as issued.

What is claimed:

1. A method of covering a drain aperture, comprising:
attaching a tileable drain cover over a drain aperture, the drain cover terminating in one or more outer peripheral edges thereof, so that an upper surface of the drain cover is substantially coplanar with an upper surface of a prefabricated shower pan adjacent to the drain cover, such that a grate free gap is defined between one or more of the peripheral edges of the drain cover and the upper surface of the prefabricated shower pan adjacent to the drain cover, which permits water or other liquid to drain into the grate free gap.

2. A method of covering a drain aperture, comprising:
attaching a tileable drain cover over a drain aperture, the drain cover terminating in one or more outer peripheral edges thereof, so that an upper surface of the drain cover is substantially coplanar with an upper surface of a partially prefabricated shower pan surface adjacent to the drain cover, such that a grate free gap is defined between one or more of the peripheral edges of the drain cover and upper surface of the partially prefabricated shower pan surface adjacent to the drain cover, which permits water or other liquid to drain into the grate free gap.

3. A method of covering a drain aperture, comprising:
attaching a tileable drain cover over a drain aperture, the drain cover terminating in one or more outer peripheral edges thereof, so that an upper surface of the drain cover is substantially coplanar with an upper surface of a mortar bed or shower pan adjacent to the drain cover, such that a grate free gap is defined between one or more of the peripheral edges of the drain cover and the upper surface of the mortar bed or shower pan adjacent to the drain cover, which permits water or other liquid to drain into the grate free gap and exit through the drain and/or the drain aperture.

4. A method of covering a drain aperture, comprising:
attaching a tileable drain cover over a drain aperture, the drain cover terminating in one or more outer peripheral edges thereof, so that an upper surface of the drain cover is substantially coplanar with an upper surface of a surface or fixture adjacent to the drain cover, such that a grate free gap is defined between one or more of the peripheral edges of the drain cover and the upper surface of the surface or fixture adjacent to the drain cover, which permits water or other liquid to drain into the grate free gap.

5. A method of covering a drain aperture, comprising:
attaching a drain cover which is covered with floor or wall covering material over a drain aperture, the floor or wall covering material covering the drain cover terminating in one or more outer peripheral edges thereof, so that an upper surface of the floor or wall covering material covering the drain cover is substantially coplanar with corresponding floor or wall covering material covering an upper surface of a prefabricated shower pan adjacent the drain cover, such that a grate free gap is defined along one or more of the peripheral edges of the floor or wall covering material covering the drain cover and the floor or wall covering material covering the prefabricated shower pan floor adjacent the drain cover, which permits water or other liquid to drain though the grate free gap and into the drain aperture.

6. A method of covering a drain aperture, comprising:
attaching a drain cover which is covered with floor or wall covering material over a drain aperture, the floor or wall covering material covering the drain cover terminating in one or more outer peripheral edges thereof, so that an upper surface of the floor or wall covering material covering the drain cover is substantially coplanar with corresponding floor or wall covering material covering an upper surface of a partially prefabricated shower pan surface adjacent the drain cover, such that a grate free gap is defined along one or more of the peripheral edges of the floor or wall covering material covering the drain cover and the floor or wall covering material covering a partially prefabricated shower pan surface adjacent the drain cover, which permits water or other liquid to drain though the grate free gap and into the drain aperture.

7. A method of covering a drain aperture, comprising:
attaching a drain cover which is covered with floor or wall covering material over a drain aperture, the floor or wall covering material covering the drain cover terminating in one or more outer peripheral edges thereof, so that an upper surface of the floor or wall covering material covering the drain cover is substantially coplanar with corresponding floor or wall covering material covering an upper surface of a mortar bed or other shower pan floor adjacent the drain cover, such that a grate free gap is defined along one or more of the peripheral edges of the floor or wall covering material covering the drain cover and the floor or wall covering material covering the mortar bed or other shower pan floor adjacent the drain cover, which permits water or other liquid to drain though the grate free gap and into the drain aperture.

8. A method of covering a drain aperture, comprising:
attaching a drain cover which is covered with floor or wall covering material over a drain aperture, the floor or wall covering material covering the drain cover terminating in one or more outer peripheral edges thereof, so that an upper surface of the floor or wall covering material covering the drain cover is substantially coplanar with corresponding floor or wall covering material covering an upper surface of a surface or fixture adjacent the drain cover, such that a grate free gap is defined along one or more of the peripheral edges of the floor or wall covering material covering the drain cover and the floor or wall covering material covering the surface or fixture adjacent the drain cover, which permits water or other liquid to drain though the grate free gap and into the drain aperture.

9. A method of concealing a plumbing drain pipe, comprising the steps of: (a) connecting a drain body to a plumbing drain pipe, the drain body including a peripheral sidewall; (2) installing floor or wall covering material adjacent to and/or over the peripheral sidewall; (3) providing a drain cover which is sized and shaped, when connected to the drain body, to create a gap between the drain body peripheral sidewall and a peripheral edge of the drain cover to permit drainage of water through said gap; and (4) installing floor or wall covering material on the drain top, grate or cover.

10. A method of concealing a plumbing drain pipe, comprising the steps of: (1) providing a drain body connected to a prefabricated shower pan, the drain body including a peripheral sidewall and defining at least one drain aperture; (2) installing the prefabricated shower pan in a shower, bath, or other enclosure space so that the drain aperture is substantially in registry with an existing plumbing drain pipe; (3) providing a tileable drain top grate or cover which is sized and shaped, when connected to the drain body, to create a gap between the drain body sidewall and a peripheral edge of the drain cover to permit drainage of water through said gap; (4) installing floor or wall covering on the prefabricated shower pan; and (5) attaching the tileable drain cover to the drain body so that it is coplanar with an adjacent untiled upper surface of the prefabricated shower pan; and (6) installing floor or wall covering on the drain cover.

11. A method of concealing a plumbing drain pipe, comprising the steps of: (1) providing a drain body connected to a partially prefabricated shower pan floor, the drain body including a peripheral sidewall and defining at least one drain aperture; (2) installing the partially prefabricated shower pan floor in a shower, bath, or other enclosure space so that the drain aperture is substantially in registry with an existing plumbing drain pipe; (3) providing a tileable drain top cover which is sized and shaped, when connected to the drain body, to create a gap between the drain body sidewall and a peripheral edge of the drain cover to permit drainage of water through said gap; (4) installing floor or wall covering on the partially prefabricated shower pan floor, and (5) attaching the tileable drain cover to the drain body so that it is coplanar with an adjacent untiled upper surface of the partially prefabricated shower pan floor; and (6) installing floor or wall covering on the drain cover.

12. A method of concealing a plumbing drain pipe, comprising the steps of: (1) providing a drain body connected to a mortar bed or other hand-made shower pan floor, the drain body including a peripheral sidewall and defining at least one drain aperture; (2) installing the mortar bed or other hand-made shower pan floor in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) installing floor or wall covering on the mortar bed or other hand-made shower pan floor; and (5) attaching the tileable drain cover to the drain body so that it is coplanar with an adjacent untiled upper surface of the mortar bed or other hand-made shower pan floor; and (6) installing floor or wall covering on the drain cover.

13. A method of concealing a plumbing drain pipe, comprising the steps of: (1) providing a drain body connected to a tiled or tileable surface or fixture, the drain body including a peripheral sidewall and defining at least one drain aperture; (2) installing the tiled or tileable surface or fixture in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) installing floor or wall covering on the surface or fixture; and (5) attaching the tileable drain cover to the drain body so that it is coplanar with an adjacent untiled upper surface of the surface or fixture; and (6) installing floor or wall covering on the drain cover.

14. A method of concealing a plumbing drain pipe, comprising the steps of: (1) providing a drain body connected to a prefabricated shower pan, the drain body including a peripheral sidewall and defining at least one drain aperture; (2) installing the prefabricated shower pan in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) attaching the tileable drain cover to the drain body so that it is coplanar with the adjacent untiled surface; (5) installing floor or wall covering on the drain cover, and on the prefabricated shower pan.

15. A method of concealing a plumbing drain pipe, comprising the steps of: (1) providing a drain body connected to a partially prefabricated shower pan surface, the drain body including a peripheral sidewall and defining at least one drain aperture; (2) installing the a partially prefabricated shower pan in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) attaching the tileable drain cover to the drain body so that it is coplanar with the adjacent untiled surface; (5) installing floor or wall covering on the drain cover, and on the partially prefabricated shower pan.

16. A method of concealing a plumbing drain pipe, comprising the steps of: (1) providing a drain body connected to a mortar bed or other hand-made shower pan floor, the drain body including a peripheral sidewall and defining at least one drain aperture; (2) installing the mortar bed or other hand-made shower pan floor in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) attaching the tileable drain cover to the drain body so that it is coplanar with the adjacent untiled surface; (5) installing floor or wall covering on the drain cover, and on the mortar bed or other hand-made shower pan floor.

17. A method of concealing a plumbing drain pipe, comprising the steps of: (1) providing a drain body connected to a tiled or tileable surface or fixture, the drain body including a peripheral sidewall and defining at least one drain aperture; (2) installing the a tiled or tileable surface or fixture, in shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) attaching the tileable drain cover to the drain body so that it is coplanar with the adjacent untiled surface; (5) installing floor or wall covering on the drain cover, and on the surface or fixture.

18. A method of concealing a plumbing drain pipe, comprising the steps of: (1) providing a drain body connected to a prefabricated shower pan, the drain body including a peripheral sidewall and defining at least one drain aperture; (2) installing the prefabricated shower pan in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) installing floor or wall covering on the drain cover, and on the prefabricated shower pan; and (5) attaching the tileable drain cover to the drain body so that it is coplanar with the adjacent untiled surface.

19. A method of concealing a plumbing drain pipe, comprising the steps of: (1) providing a drain body connected to a partially prefabricated shower pan surface, the drain body including a peripheral sidewall and defining at least one drain aperture; (2) installing the a partially prefabricated shower pan in a shower, bath, or other enclosure space so that the drain aperture is substantially in registry with an existing plumbing drain pipe; (3) providing a tileable drain top grate or cover which is sized and shaped, when connected to the drain body, to create a gap between the drain body sidewall and a peripheral edge of the drain cover to permit drainage of water through said gap; (4) installing floor or wall covering on the drain cover, and on the partially prefabricated shower pan; (5) attaching the tileable drain cover to the drain body so that it is coplanar with the adjacent untiled surface.

20. A method of concealing a plumbing drain pipe, comprising the steps of: (1) providing a drain body connected to a mortar bed or other hand-made shower pan floor, the drain body including a peripheral sidewall and defining at least one drain aperture; (2) installing the mortar bed or other hand-made shower pan floor in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) installing floor or wall covering on the drain cover, and on the mortar bed or other hand-made shower pan floor; (5) attaching the tileable drain cover to the drain body so that it is coplanar with the adjacent untiled surface.

21. A method of concealing a plumbing drain pipe, comprising the steps of: (1) providing a drain body connected to a tiled or tileable surface or fixture, the drain body including a peripheral sidewall and defining at least one drain aperture; (2) installing the tiled or tileable surface or fixture in a shower, bath, or other enclosure space so that the drain aperture is substantially in registry with an existing plumbing drain pipe; (3) providing a tileable drain cover which is sized and shaped, when connected to the drain body, to create a gap between the drain body sidewall and a peripheral edge of the drain cover to permit drainage of water through said gap; (4) installing floor or wall covering on the drain cover, and on the surface or fixture; (5) attaching the tileable drain cover to the drain body so that it is coplanar with the adjacent untiled surface.

22. A method of concealing a plumbing drain pipe, the plumbing drain pipe being situated in a sub floor, comprising the steps of: (1) connecting a drain body substantially in registry with an existing plumbing drain pipe; (2) providing a removable drain cover which is sized and shaped, when connected to the drain body, to create a gap between the drain body and a peripheral edge of the drain cover, to permit drainage of water through said gap.

23. The method of claim 22, further including the steps of providing a shower pan floor made of two or more sections, at least one of the sections defining a drain body-receiving cutout therein adapted to nest with the drain body, placing the shower pan floor sections in registry with the subfloor such that the cutout nests with the drain body, and attaching floor or wall covering material on upper surfaces of the floor sections and an upper surface of the cover.

24. A method of concealing a plumbing drain pipe, comprising the steps of: (1) connecting a drain body substantially in registry with an existing plumbing drain pipe; (2) providing a removable and tileable drain cover which is sized and shaped, when connected to the drain body, to create a gap between the drain body and a peripheral edge of the drain cover to permit drainage of water through said gap.

25. A method of concealing a plumbing drain pipe which includes the steps of: (1) installing a prefabricated shower pan in an enclosure space such as a shower or bath enclosure, so that the plumbing drain pipe is substantially in registry with a location on the pan for placement of a concealed drain; (2) connecting a drain body to the prefabricated shower pan by creating an aperture in said pan into which is adapted to be attached the drain body, the drain body including a peripheral sidewall and defining at least one drain aperture; (3) placing a drain cover in registry with the drain body which is sized and shaped to create a gap between the drain body and one or more peripheral edges of the drain cover to permit drainage of water through said gap; (4) attaching floor or wall covering to the prefabricated shower pan and the drain cover.

26. A method of concealing a plumbing drain pipe which includes the steps of: (1) installing a partially prefabricated shower pan floor in an enclosure space such as a shower or bath enclosure, so that the plumbing drain pipe is substantially in registry with a location on the pan for placement of a hidden drain; (2) connecting a drain body to the partially prefabricated shower pan floor by creating an aperture in said pan into which is adapted to be attached the drain body, the drain body including a peripheral sidewall and defining at least one drain aperture; (3) placing a drain cover in registry with the drain body which is sized and shaped to create a gap between the drain body and one or more peripheral edges of the drain cover; to permit drainage of water through said gap; (4) attaching floor or wall covering to the partially prefabricated shower pan and the drain cover.

27. A method of concealing a plumbing drain pipe which includes the steps of: (1) installing a mortar bed or other hand-made shower pan floor in a enclosure space such as a shower or bath enclosure so that the plumbing drain pipe is substantially in registry with a location on the floor for placement of a hidden drain; (2) connecting a drain body to the mortar bed or other hand-made shower pan floor by creating a recess in said pan into which is adapted to be attached the drain body, the drain body including a peripheral sidewall and defining at least one drain aperture; (3) placing a drain cover in registry with the drain body which is sized and shaped to create a gap between the drain body and one or more peripheral edges of the drain cover to permit drainage of water through said gap; and (4) attaching floor or wall covering to the mortar bed or other hand-made shower pan floor and the drain cover.

28. A method of concealing a plumbing drain pipe which includes the steps of: (1) installing surface or fixture in a enclosure space such as a shower or bath enclosure, so that the plumbing drain pipe is substantially in registry with a location on the surface or fixture for placement of a hidden drain; (2) connecting a drain body to the surface or fixture by creating an aperture in said surface or fixture into which is adapted to be attached the drain body, the drain body including a peripheral sidewall and defining at least one drain aperture; (3) placing a drain cover in registry with the drain body which is sized and shaped to create a gap between the drain body and one or more peripheral edges of the drain cover to permit drainage of water through said gap; and (4) attaching floor or wall covering to the surface or fixture and the drain cover.

29. A method of concealing a plumbing drain pipe which includes the steps of: (1) installing a partially prefabricated shower pan in an enclosure space such as a shower or bath enclosure, the pan comprised of a shower pan floor, so that the plumbing drain pipe is substantially in registry with a location on the pan floor where a concealed drain is to be installed; (2) connecting a drain body to the partially prefabricated shower pan floor by creating an aperture in said pan floor substantially in registry with the plumbing drain pipe into which is adapted to be attached the drain body, the drain body including a peripheral sidewall and defining at least one drain aperture; (4) placing a drain cover in registry with the drain body which is sized and shaped to create a gap between the drain body and one or more peripheral edges of the drain cover; to permit drainage of water through said gap; (5) attaching floor or wall covering to the partially prefabricated shower pan floor and the drain cover.

30. A method of concealing a plumbing drain pipe which includes the steps of: (1) installing a partially prefabricated shower pan in an enclosure space such as a shower or bath enclosure, the pan comprised of a shower pan floor, so that the plumbing drain pipe is substantially in registry with a location on the pan floor where a concealed drain is to be installed; (2) connecting a drain body to the partially prefabricated shower pan floor by creating an aperture in said pan floor substantially in registry with the plumbing drain pipe into which is adapted to be attached the drain body, the drain body including a peripheral sidewall and defining at least one drain aperture; (4) placing a drain cover in registry with the drain body which is sized and shaped to create a gap between the drain body and one or more peripheral edges of the drain cover; to permit drainage of water through said gap; (5) attaching floor or wall covering to the partially prefabricated shower pan floor and the drain cover.
